(19) United States
(12) Patent Application Publication
(10) Pub. No.: US 2025/0073804 A1
(43) Pub. Date: Mar. 6, 2025

(54) WIRE BRAKE FOR WELDING CABLE AND WELDING TORCH SYSTEMS

(71) Applicant: Illinois Tool Works Inc., Glenview, IL (US)

(72) Inventors: Bradley Eugene Whipple, Ontario (CA); Ryan Lizotte, Ontario (CA)

(21) Appl. No.: 18/807,044

(22) Filed: Aug. 16, 2024

Related U.S. Application Data
(60) Provisional application No. 63/535,614, filed on Aug. 31, 2023.

(51) Int. Cl. B23K 9/32; B23K 9/133; B23K 37/02

(52) U.S. Cl. CPC B23K 9/32; B23K 9/133; B23K 37/02

(57) ABSTRACT

An example wire brake assembly for a welding torch is provided. An example wire brake assembly for a welding torch includes a housing configured to connect a welding cable to a rotating power connector for a welding torch or a welding torch neck, and a piston assembly arranged within the housing to apply a force to a welding wire. An example piston assembly includes a first end and an air inlet at a second end, a piston, a bore configured to receive the piston, at least one biasing device for biasing the piston, and an actuator arranged at the second end of the piston assembly, wherein the actuator applies a force to the welding wire in order to maintain the welding wire in a predetermined position.

### CROSS-REFERENCE TO RELATED APPLICATION

This application claims benefit of priority from U.S. Provisional Patent Application No. 63/535,614, filed Aug. 31, 2023, which is hereby incorporated by reference in its entirety herein.

### FIELD OF THE DISCLOSURE

This disclosure relates generally to robotic welding and more particularly, to wire brakes for welding cables and welding torch systems.

### BACKGROUND

A welding torch is typically used to perform arc welding. The welding torch receives current, shielding gas, and electrode welding wire from a welding cable that runs through the robotic arm of the welding torch to a gooseneck or conductor tube of the welding torch (e.g. welding torch neck). Some welding torches may include a welding wire brake at a front end of the welding torch.

### SUMMARY

These and other features and advantages of the disclosure will be more fully understood from the following detailed description of the disclosure taken together with the accompanying drawings.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example robotic welding system, in accordance with aspects of this disclosure.

FIG. 2 illustrates a block diagram of an example integrated wire brake that may be used to implement the robotic welding system of FIG. 1, in accordance with aspects of this disclosure.

FIG. 3 illustrates a sectional view of the integrated wire brake described with respect to FIG. 2, in accordance with aspects of this disclosure.

FIG. 4 illustrates a schematic diagram of the integrated wire brake of FIG. 2, in accordance with aspects of this disclosure.

FIG. 5 illustrates a sectional view of an example integrated wire brake of FIG. 2.

FIG. 6 is another sectional view of an example integrated wire brake of FIG. 2.

FIG. 7 is a flowchart illustrating an example method of removing and replacing the integrated wire brake of FIG. 2.

The figures are not necessarily to scale. Where appropriate, similar or identical reference numbers are used to refer to similar or identical components.

### DETAILED DESCRIPTION

This disclosure relates to welding generally, and more particularly to wire brakes for welding systems. In particular, example welding wire brake assemblies are disclosed that can be integrated into welding cables, and that can be easily removed and replaced.

Conventional wire brakes are installed on the welding torch housing at the front of the welding torch body. An air supply line travels outside of the robotic arm to the front of the welding torch body where the welding wire brake assembly is typically located. During manipulation of the welding torch by a user or a robot, cables such as welding cables and air supply lines are subject to twisting and other stresses as the welding torch is moved and rotated. Twisting and stress can be problematic as cables and supply lines are subjected to stress and strain, and can cause failure of the welding cable and/or supply lines. Conventional wire brake air supply lines leave a few inches of slack in the air supply line so that the air supply line can move with the rotation of the robot wrist. Even so, the rotation of the robotic arm causes stress on the air supply line, and can prematurely wear out the air supply line, causing downtime on production lines.

Conventional wire brakes are typically sold as a separate assembly that must be mounted on a welding torch. In order to include a welding wire brake with a welding torch, conventional wire brakes require a special outer body, special inner brass body, and an additional wire guide inside the welding torch. The additional parts needed create inefficiencies as the additional parts require additional part numbers that need to be managed by clients on a production floor. Additionally, different welding torch models have welding wire brakes with different part numbers specific to each model, and if customers request a welding wire brake after the initial installation of the welding torch, a new longer torch body must be ordered, which requires ordering part numbers associated with the new longer torch body, and also changes a tool center point (TCP) of the welding torch, which requires additional non-production time.

The present disclosure provides a welding wire brake assembly that can be integrated into the welding cable and be in-line with the welding cable, rather than being a separate assembly that is mounted into the torch body. Integrating the welding wire brake into the welding cable assembly in the robotic arm (rather than at the front of the welding torch) simplifies the number of welding torches that need to be manufactured and assembled.

Additionally, because the integrated wire brake is located in the welding cable assembly, the air supply line that provides compressed air to the welding wire brake will no longer be affected by stress/strain caused by rotation of the robot wrist. By having the welding wire brake situated before the robot wrist, the welding wire brake air supply line will remain stationary as the welding torch rotates, thereby increasing the life of the air supply line and creating less downtime for the customer. Advantageously, the integrated wire brake will also be protected by the wrist of the robot and not exposed to the welding environment where debris and heat can affect the functionality over time. Also, there is less chance that the integrated wire brake will be damaged due to a collision or by an operator inadvertently bumping into the welding wire brake.

Moreover, because the integrated wire brake is located in the welding cable assembly, the tool center point (TCP) may remain the same when an integrated wire brake is added and/or replaced in a welding torch system since the front of the welding torch will not need to be removed. The integrated wire brake may quickly be replaced without changing the TCP or affecting other aspects of the welding torch, thereby reducing unplanned downtime for customers. Simpler cable liner measuring and replacements can be performed off-line, with only the cable in-hand, since measurements for the welding torch front end components are not needed in order to determine the welding cable length when replacing a cable.

Disclosed example wire braking assemblies include a housing configured to connect a welding cable to a rotating power connector for a welding torch; and a piston assembly arranged within the housing to apply a force to a welding wire. In some example wire brake assemblies the piston assembly may further include: a first end; a second end may include an air inlet arranged at the second end; a piston; a bore configured to receive the piston; at least one biasing device for biasing the piston; and an actuator arranged at the second end of the piston assembly, where the actuator applies the force to the welding wire in order to maintain the welding wire in a predetermined position.

In some example wire brake assemblies, the air inlet is in a static position relative to movement of the welding torch. Example wire brake assemblies include a welding wire guide configured to receive the actuator from the piston assembly. Example wire brake assemblies include a welding wire liner connected to the welding wire guide at either end of the welding wire guide. Some example wire brake assemblies may be configured to be installed between a J6 joint and a wire feeder. Some example wire brake assemblies may remain coupled to the welding torch while the welding torch rotates. Some example wire brake assemblies may be integrated with the welding cable.

Disclosed example cable connection assemblies include a housing including a first end and a second end, and a piston assembly arranged within the housing to apply a force to a welding wire. Some example cable connection assemblies also include a connection for a weld cable at the first end; and a rotating power connector at the second end. In some example cable connection assemblies, the piston assembly further may include: a first piston assembly end; an air inlet arranged at a second piston assembly end; a piston; a bore configured to receive the piston; at least one biasing device for biasing the piston; and an actuator arranged at the second piston assembly end, where the actuator applies the force to the welding wire in order to maintain the welding wire in a predetermined position. Some example cable connection assemblies may include a welding wire guide configured to receive the actuator from the piston assembly. The rotating power connector may be coupled to a welding torch, and the rotating power connector may remain coupled to the welding torch while the welding torch rotates. Some example cable connection assemblies are integrated with the welding cable. Some example cable connection assemblies are configured to be installed between a J6 joint and a wire feeder.

Disclosed example wire brake assemblies include a housing configured to connect a welding cable to a welding torch neck; and a piston assembly arranged within the housing to apply a force to a welding wire, where the wire brake assembly is positioned in a path between the welding cable and the welding torch neck. In some example wire brake assemblies, the piston assembly may include: a first end; an air inlet arranged at a second end; a piston; a bore configured to receive the piston; at least one biasing device for biasing the piston; and an actuator arranged at the second end of the piston assembly, where the actuator applies the force to the welding wire in order to maintain the welding wire in a predetermined position. Some example wire brake assemblies are configured to be installed between a J6 joint and a wire feeder. Some example wire brake assemblies are integrated with the welding cable. Some example wire brake assemblies are directly coupled to the welding torch neck. Some example wire brake assemblies are positioned in a robotic through-arm.

As used herein, the terms “first” and “second” may be used to enumerate different components or elements of the same type, and do not necessarily imply any particular order.

As used herein, the words “exemplary” and “example” mean “serving as an example, instance, or illustration.” The examples described herein are not limiting, but rather are exemplary only. It should be understood that the described examples are not necessarily to be construed as preferred or advantageous over other examples. Moreover, the terms “examples of the invention,” “examples,” or “invention” do not require that all examples of the invention include the discussed feature, advantage, or mode of operation.

The term “welding-type system,” as used herein, includes any device capable of supplying power suitable for welding, plasma cutting, induction heating, Carbon Arc Cutting-Air (e.g., CAC-A), and/or hot wire welding/preheating (including laser welding and laser cladding), including inverters, converters, choppers, resonant power supplies, quasi-resonant power supplies, etc., as well as control circuitry and other ancillary circuitry associated therewith.

As used herein, the term “welding-type power” refers to power suitable for welding, plasma cutting, induction heating, CAC-A and/or hot wire welding/preheating (including laser welding and laser cladding). As used herein, the term “welding-type power supply” and/or “power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, the term “torch,” “welding torch,” “welding tool” or “welding-type tool” refers to a device configured to be manipulated to perform a welding-related task, and can include a hand-held welding torch, robotic welding torch, gun, gouging tool, cutting tool, or other device used to create the welding arc.

As used herein, the term “welding mode,” “welding process,” “welding-type process” or “welding operation” refers to the type of process or output used, such as current-controlled (CC), voltage-controlled (CV), pulsed, gas metal arc welding (GMAW), flux-cored arc welding (FCAW), gas tungsten arc welding (GTAW, e.g., TIG), shielded metal arc welding (SMAW), spray, short circuit, CAC-A, gouging process, cutting process, and/or any other type of welding process.

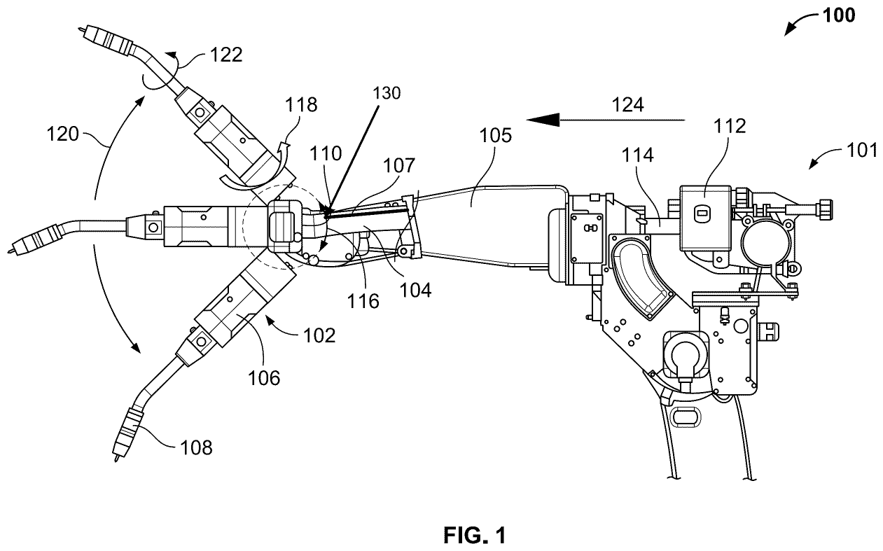

FIG. 1 illustrates an example robotic welding system 100. The robotic welding system 100 includes a through-arm robot 101 having a welding torch 102 and a welding cable 104 and air supply line 107 that travels through an interior of a robot arm 105 of the robot 101.

The welding torch 102 includes a welding torch body 106 and front components 108. The example robot 101 manipulates the front components 108 via the welding torch body 106 to position the welding torch 102 for welding operations. FIG. 1 illustrates the example welding torch 102 in multiple positions resulting from manipulation by the robot 101.

The welding cable 104 is connected to the welding torch body 106 at a first end 110 of the robot 101, and is connected to a welding wire feeder 112 at a second end 114. The welding cable 104 delivers wire electrode, welding power, and/or welding gas to the welding torch 102. The air supply line 107 provides air to an integrated wire brake assembly 130 in the robot arm 105.

The robot 101 may manipulate the welding torch 102 in multiple degrees of freedom. Two particular movements by the robot 101 affect the contour (e.g., stress and/or strain) of the welding cable 104. A joint 5 (J5) 116 that applies bending 120 to the welding torch 102, and a joint 6 (J6) 118 applies twist to the welding torch 102. An example bending limit 120 for the J5 joint 116 is +/−140 degrees. An example twist limit 122 for the J6 joint 118 is +/−360 degrees. Movements of other joints in the robot 101 change the absolute position of the welding torch 102, but do not change the contour of the welding cable 104 or the air supply line 107. For example, as the J5 joint 116 bends, the welding cable 104 may be pulled by a force similar to 124 and the length of the welding cable 104 may grow and shrink. As the J6 joint 118 twists, the welding cable 104 may twist.

The robot 101 may include an integrated wire brake 130 located at a stationary portion of the robot arm 105, between the first end 110 and the second end 114 of the robot 101, and before the J5 joint 116 and the J6 joint 118 which provide the movements described above. In some examples, the integrated wire brake 130 is located near the first end 110. In some other examples, the integrated wire brake is located at any location between the first end 110 and the second end 114 of the robot 101.

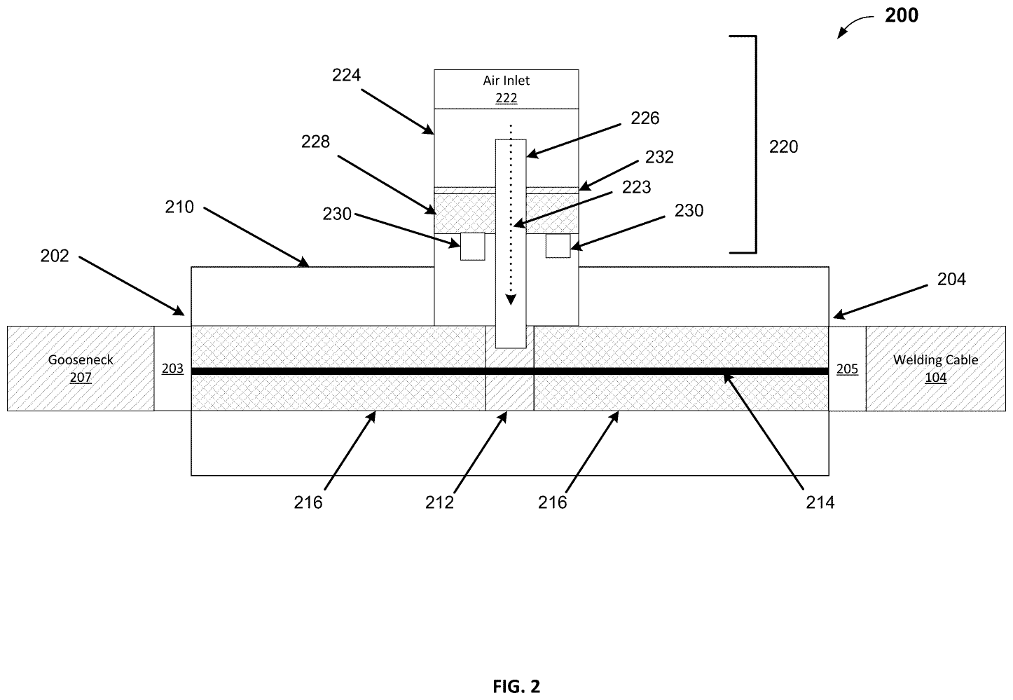

FIG. 2 illustrates a block diagram 200 of an example integrated wire brake 130 that may be used to implement the robotic welding system of FIG. 1, in accordance with aspects of this disclosure. In some examples, the integrated wire brake 130 includes a housing 210 and a piston assembly 220. The housing 210 has a first housing end 202 and a second housing end 204, and includes a welding wire guide 212, a welding wire 214, and a welding wire liner 216. The piston assembly 220 includes an air inlet 222, a piston 224, an actuator 226, a piston bore 228, one or more biasing elements 230, and one or more seals 232.

At the first housing end 202, the integrated wire brake 130 may connect to a gooseneck 207 via a rotating power connector 203. At the second housing end, the integrated wire brake 130 may connect to a welding cable 104 via a connector 205, which in turn connects to a welding wire feeder 112, such as described above with reference to FIG. 1. The rotating power connector 203 and the connector 205 may be coupled to the housing 210 at the first housing end 202 and the second housing end 204, respectively, using one or more fasteners, such as a threaded interface, locking screws, set screws, or a crimp connector as a list of non-limiting examples. A crimp connector may be any type of coupler that provides a radial force to secure the housing 210 to the rotating power connector 203 or the connector 205 (e.g., a crimped-style fitting, a compression fitting, a threaded compression fitting, etc.). The crimp connector may be secured to the housing 210 via a connection, such as a thread and set screw connection, but may also include a press-fit, knurled press-fit, snap-fit, screws, bolts, adhesive, a weld, braze, or other type of fastener. Additionally or alternatively, the conductors of the welding cable may be ultrasonically welded, or otherwise bonded, to the rotating power connector 203 and/or the connector 205. Conductive wires (e.g., copper wires) of the welding cable may be crimped to form a solid electric connection between the welding cable and the crimp connector. In some examples, the rotating power connector 203 may be a non-rotating power connector. The connector 205 that connects the housing 210 to the welding cable 104 at the second housing end 204 may be a threaded interface, locking screws, set screws, or a crimp connector, as a list of non-limiting examples. The rotating power connector 230 allows the welding cable 104 and air supply line 107 to remain neutral while the welding torch 102 performs movements and/or manipulations, thereby reducing stress and strain on the welding cable 104 and/or air supply line 107.

In some other examples, the housing 210 is directly connected to the gooseneck 207, and the air supply line 107 may rotate with the J5 116 but not with the J6 118 while being positioned between the first end 110 and second end 114 of the robot 101 as described above with reference to FIG. 1, thereby reducing strain/stress on the air supply line 107. The gooseneck 207 may be retained to the housing 210 using cam-type fasteners, such as cam levers, cam clamps, cam locks, clamp handles, clamp levers, spring catches, latches, quick-release fasteners, retention bolts, etc.

The housing 210 includes a welding wire guide 212 that receives the actuator 226 from the piston assembly 220. Welding wire 214 may be run through a welding wire liner 216, which runs through a longitudinal axis of the housing 210. The welding wire liner 216 may run on either side of the welding wire guide 212, with a gap in the welding wire liner 216 for the welding wire guide 212 to receive the actuator 226 that places a force 223 on the welding wire 214.

The piston assembly 220 includes an air inlet 222 at one end to receive compressed air that is used to move the piston 224 through a piston bore 228, and includes an actuator 226 at an opposite end closest to the housing 212. The piston 224 applies a force 223 to the welding wire 214 via the actuator 226. The actuator 226 is arranged along a longitudinal axis of the piston 224 and may be a dowel, a rod, a peg, a pin, as non-limiting examples. The actuator 226 places the force 223 on the welding wire 214 to maintain the welding wire at a predetermined position. One or more biasing elements 230, such as springs, surround the actuator 226. The one or more biasing elements 230 serve to bias the piston bore 228 away from the welding wire 214 and towards the air inlet 222 when air pressure is released. The one or more seals 232 may be located between the piston bore 228 and the air inlet 222, to help provide compressed air that is provided through the air inlet 222. The one or more seals 232 may include washers, O-rings, or similar seals, arranged at the end of the piston assembly 220 from which the actuator 226 extends.

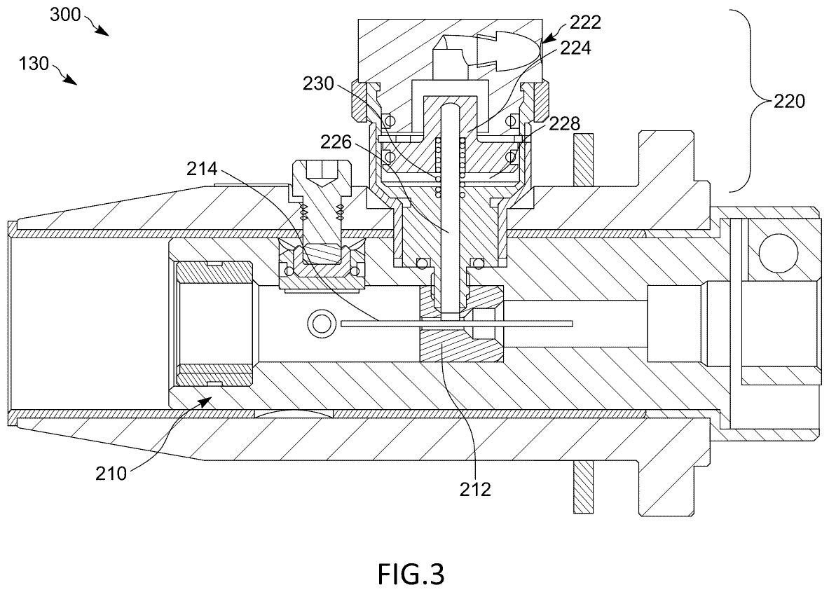

FIG. 3 illustrates a sectional view 300 of the integrated wire brake 130 described with respect to FIG. 2, in accordance with aspects of this disclosure. The integrated wire brake 130 includes a housing 210 and a piston assembly 220. The housing 210 includes a welding wire guide 212 that receives the actuator 226 from the piston assembly 220. Welding wire 214 may be run through the housing 210.

The piston assembly 220 includes an air inlet 222, a piston 224, an actuator 226, a piston bore 228, and one or more biasing elements 230. The piston bore 228 is configured to receive the piston 224. The piston 224 applies a force 223 to the welding wire 214 via the actuator 226. The actuator 226 is arranged along a longitudinal axis of the piston 224. The actuator 226 places the force 223 on the welding wire 214 to maintain the welding wire at a predetermined position. One or more biasing elements 230, such as springs, surround the actuator 224. The one or more biasing elements 230 serve to bias the piston bore 228 away from the welding wire 214 and towards the air inlet 222 when air pressure is released.

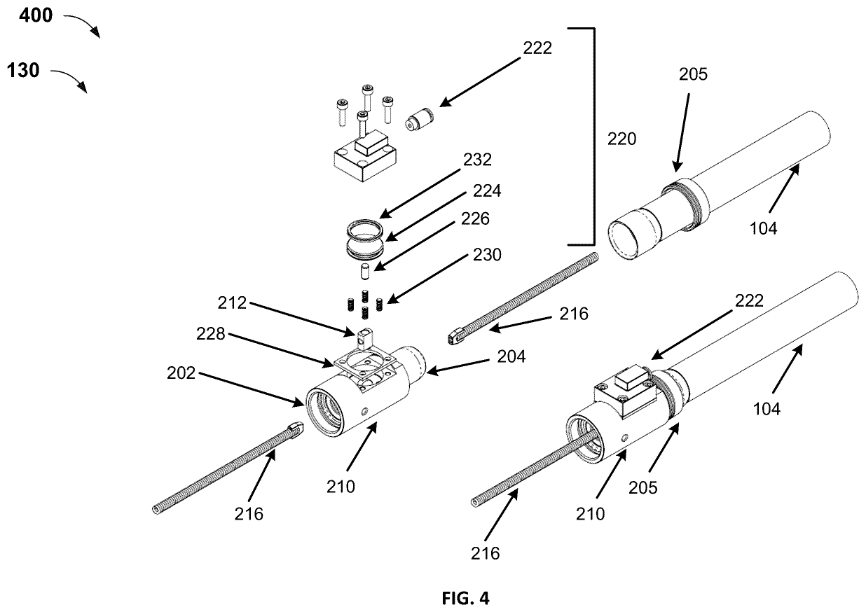

FIG. 4 illustrates a schematic diagram 400 of the integrated wire brake 130 of FIG. 2, in accordance with aspects of this disclosure. The integrated wire brake 130 includes a housing 210 and a piston assembly 220. The housing 210 includes a welding wire guide 212 that receives the actuator 226 from the piston assembly 220. Welding wire 214 may be run through a welding wire liner 216, which runs through the length of the housing 210. The housing 210 includes a first housing end 202, a second housing end 204, a welding wire guide 212, a welding wire 214, and a welding wire liner 216.

A connector 205 may be coupled to the housing 210 at the second housing end 204 using one or more fasteners, such as a threaded interface, locking screws, set screws, or a crimp connector as a list of non-limiting examples.

The piston assembly 220 includes an air inlet 222, a piston 224, an actuator 226, a piston bore 228, one or more biasing elements 230, and one or more seals 232. The piston bore 228 is configured to receive the piston 224. One or more biasing elements 230, such as springs, surround the actuator 224. The one or more biasing elements 230 serve to bias the piston bore 228 away from the welding wire 214 and towards the air inlet 222 when air pressure is released. The one or more seals 232 may be located between the piston bore 228 and the air inlet 222, to help provide compressed air that is provided through the air inlet 222.

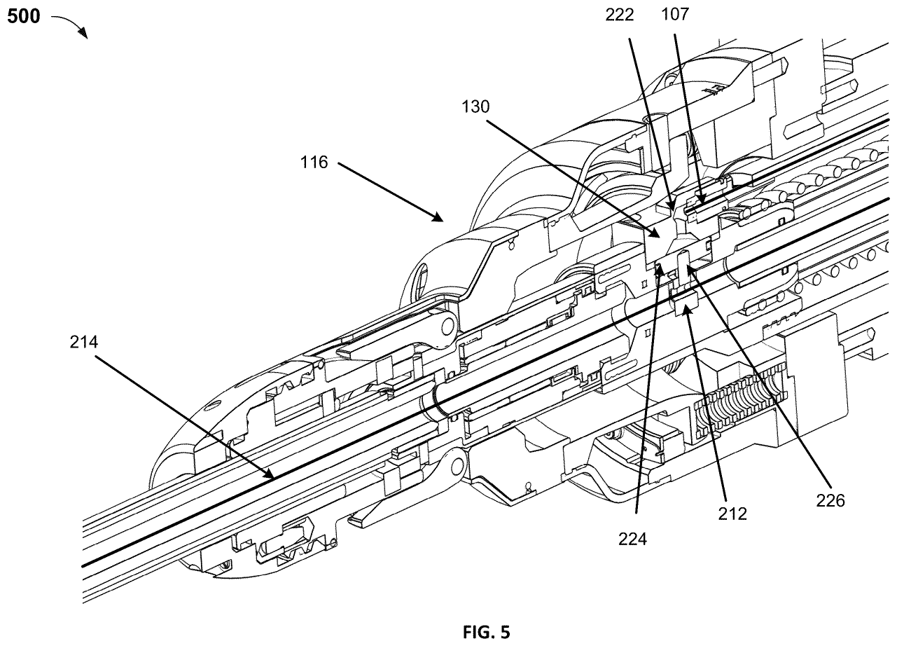

FIG. 5 is a sectional view of an example integrated wire brake of FIG. 2. The integrated wire brake 130 is depicted relative to the J5 116 where movement of the robotic arm 101 will not affect the air supply line 107. For example, the air inlet 222 is in a static position relative to movement of the welding torch, which occurs at 116. Welding wire 214 may be run through the length of the robotic arm 101. The piston 224 applies a downward force on the welding wire 214 via the actuator 226 to maintain the welding wire 214 at a predetermined position. One or more biasing elements 230, such as springs, surround the actuator 224.

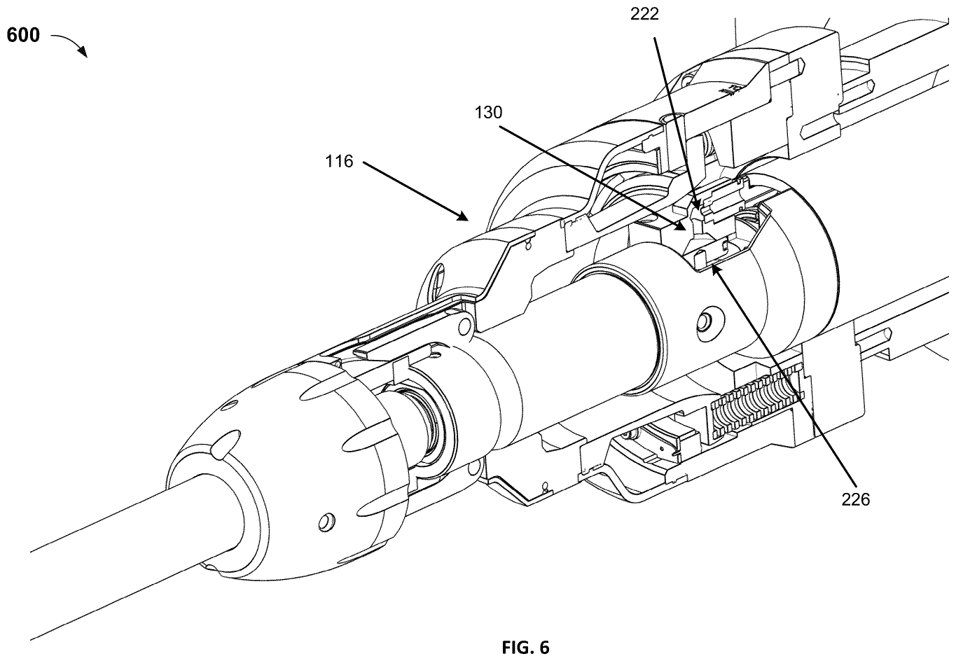

FIG. 6 is another sectional view of an example integrated wire brake of FIG. 2.

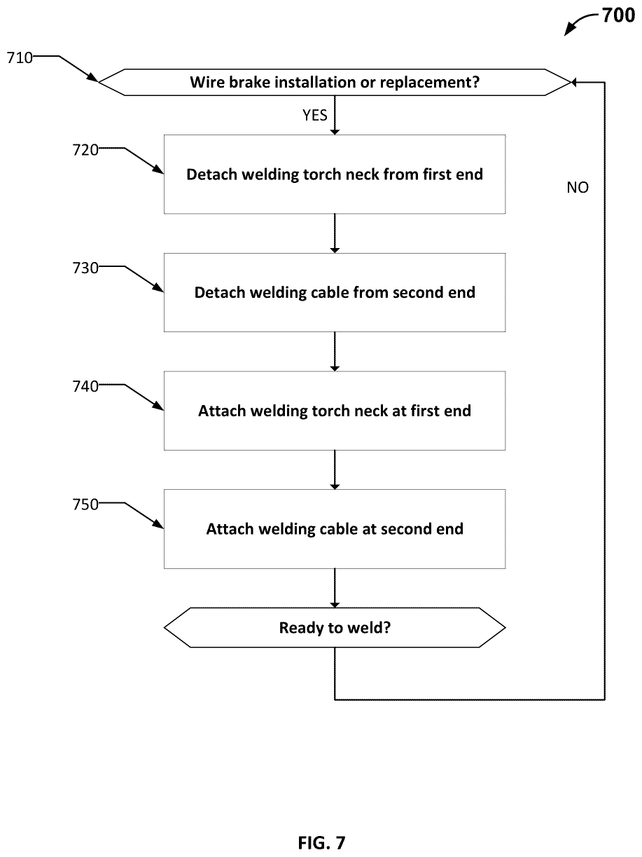

FIG. 7 is a flowchart 700 illustrating an example method of removing and replacing the integrated wire brake 130 of FIG. 1. In some examples, when the integrated wire brake needs to be replaced (block 710), the integrated wire brake may be removed by detaching the first housing end of the integrated wire brake from a welding torch neck/gooseneck. The gooseneck may be connected to the integrated wire brake directly or via a rotating power connector (block 720).

The integrated wire brake may be removed at a second housing end by detaching a welding cable, which is connected to the welding cable via a connector as described above (block 730). The integrated wire brake may be replaced/installed by attaching the rotating power connector (or a new rotating power connector) at the second housing end or directly connecting the integrated wire brake to the rotating power connector (block 740). The welding system is now ready to weld (block 750).

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A wire brake assembly comprising:
a housing configured to connect a welding cable to a rotating power connector for a welding torch; and
a piston assembly arranged within the housing to apply a force to a welding wire.

2. The wire brake assembly of claim 1, wherein the piston assembly further comprises:
a first end;
a second end comprising an air inlet arranged at the second end;
a piston;
a bore configured to receive the piston;
at least one biasing device for biasing the piston; and
an actuator arranged at the second end of the piston assembly, wherein the actuator applies the force to the welding wire in order to maintain the welding wire in a predetermined position.

3. The wire brake assembly of claim 2, wherein the air inlet is in a static position relative to movement of the welding torch.

4. The wire brake assembly of claim 2, further comprising a welding wire guide configured to receive the actuator from the piston assembly.

5. The wire brake assembly of claim 4, further comprising a welding wire liner connected to the welding wire guide at either end of the welding wire guide.

6. The wire brake assembly of claim 1, wherein the wire brake assembly is configured to be installed between a J6 joint and a wire feeder.

7. The wire brake assembly of claim 1, wherein the wire brake assembly remains coupled to the welding torch while the welding torch rotates.

8. The wire brake assembly of claim 1, wherein the wire brake assembly is integrated with the welding cable.

9. A cable connection assembly comprising:
a housing comprising a first end and a second end;
a piston assembly arranged within the housing to apply a force to a welding wire;
a connection for a weld cable at the first end; and
a rotating power connector at the second end.

10. The cable connection assembly of claim 9, wherein the piston assembly further comprises:
a first piston assembly end;
an air inlet arranged at a second piston assembly end;
a piston;
a bore configured to receive the piston;
at least one biasing device for biasing the piston; and
an actuator arranged at the second piston assembly end, wherein the actuator applies the force to the welding wire in order to maintain the welding wire in a predetermined position.

11. The cable connection assembly of claim 10, further comprising a welding wire guide configured to receive the actuator from the piston assembly.

12. The cable connection assembly of claim 9, wherein the rotating power connector is coupled to a welding torch, and the rotating power connector remains coupled to the welding torch while the welding torch rotates.

13. The cable connection assembly of claim 9, wherein the cable connection assembly is integrated with the welding cable.

14. The cable connection assembly of claim 9, wherein the cable connection assembly is configured to be installed between a J6 joint and a wire feeder.

15. A wire brake assembly comprising:
a housing configured to connect a welding cable to a welding torch neck; and
a piston assembly arranged within the housing to apply a force to a welding wire, wherein the wire brake assembly is positioned in a path between the welding cable and the welding torch neck.

16. The wire brake assembly of claim 15, wherein the piston assembly comprises:
a first end;
an air inlet arranged at a second end;
a piston;
a bore configured to receive the piston;
at least one biasing device for biasing the piston; and
an actuator arranged at the second end of the piston assembly, wherein the actuator applies the force to the welding wire in order to maintain the welding wire in a predetermined position.

17. The wire brake assembly of claim 15, wherein the wire brake assembly is configured to be installed between a J6 joint and a wire feeder.

18. The wire brake assembly of claim 15, wherein the wire brake assembly is integrated with the welding cable.

19. The wire brake assembly of claim 15, wherein the wire brake assembly is directly coupled to the welding torch neck.

20. The wire brake assembly of claim 15, wherein the wire brake assembly is positioned in a robotic through-arm.
